(19) United States
(12) Patent Application Publication
(10) Pub. No.: US 2016/0134710 A1
(43) Pub. Date: May 12, 2016

(54) COMMUNICATION METHOD IN WIRELESS LOCAL ACCESS NETWORK AND WIRELESS APPARATUS THEREFOR

(71) Applicant: ELECTRONICS AND TELECOMMUNICATIONS RESEARCH INSTITUTE, Daejeon-si (KR)

(72) Inventor: Cheol RYU, Daejeon-si (KR)

(21) Appl. No.: 14/934,832

(22) Filed: Nov. 6, 2015

(30) Foreign Application Priority Data
Nov. 6, 2014 (KR) 10-2014-0153947
Nov. 4, 2015 (KR) 10-2015-0154442

(51) Int. Cl. H04L 29/08; H04W 48/08

(52) U.S. Cl. CPC H04L 67/16; H04W 48/08; H04W 84/12

(57) ABSTRACT

A communication method in a wireless local access network (WLAN) and a wireless apparatus therefor. According to the communication method, a station (STA) receives frames each of which contains upper layer service discovery protocol information from one or more access points (APs). The STA transmits an association request frame to an AP which is selected based on upper layer service discovery protocol information received from the APs. Then, the STA proceeds with an association process with the selected AP. The upper layer service discovery protocol information may be represented in a bitmap scheme whereby each of service discovery protocols contained in the upper layer service discovery protocol information is indicated as to whether it is supported by the AP; an enumeration scheme whereby identifier of each of supported service discovery protocols is included in the upper layer service discovery protocol information; or a hybrid scheme.

### CROSS REFERENCE TO RELATED APPLICATION

This application claims the benefit under 35 U.S.C. §119(a) of Korean Patent Application Nos. 10-2014-0153947, filed on Nov. 6, 2014, and 10-2015-0154442, filed on Nov. 4, 2015, the entire disclosures of which are incorporated herein by reference for all purposes.

### BACKGROUND

1. Field

The following description relates to a wireless local access network (WLAN), and more specifically, to a technology for communication between a user terminal and an access point (AP) in WLAN.

2. Description of the Related Art

With the development of information and communication technology, a wide variety of wireless communication technologies have been developed. A wireless local access network (WLAN) is one wireless communication technology, which allows wireless access of a mobile terminal to an external network, such as the Internet, in a specific service delivery area, such as a home or office. Examples of the mobile terminal may include a personal digital assistant (PDA), a laptop computer, a portable multimedia player (PMP), a smart phone, and the like.

With the increasing distribution and use of user terminals equipped with a WLAN function, as well as smart phones and tablet computers, (hereinafter, will be referred to as “stations (STAs)”) and the growing use of the Internet, installation of access points (APs) has increased, as well as the AP's service coverage has expanded. That is, the number of basic service sets (BSSs) that operate in an infrastructure mode in WLAN is increasing, and the coverage of each BSS is expanding. Consequently, coverages of different BSSs overlap each other, and hence an STA has a number of APs available to be associated with in the same area.

In this case, users choose a specific AP with which to be associated, generally based on an identifier (name) of each AP. Once the STA is connected to a network through the specific AP and completes an association process after acquiring necessary information for communication or completing an authentication process, then the STA becomes possible to access an external network, such as the Internet.

As such, when the STA in the infrastructure mode in the existing WLAN intends to access the Internet, the STA has to perform an association process with an AP and then go through the Internet protocol network setup. After the association process, it is possible to discover an upper layer service using service discovery protocols (SDPs), such as Bonjour or UPnP as used in a wired LAN.

According to the existing technologies as described above, when coverages of different BSSs overlap each other, users first need to select a BSS to participate in from among the several BSSs. Identifier information of APs is however the almost only information that can be utilized in the selection of AP. For example, the Institute of Electrical and Electronics Engineers (IEEE) 802.11u (Interworking with External Network) specifies procedures of providing information about accessible external network. According to this, before performing an association process, an STA can identify a mobile communication service provider of an external network that is accessible through a corresponding BSS, but it is difficult for the STA to obtain other information. For example, participating in each accessible BSS is the only way for the users to achieve information about service discovery protocols used to discover upper layer services provided by a specific BSS.

### SUMMARY

Accordingly, in one aspect, there is provided a communication method of a station (STA) and an access point (AP) in a wireless local access network (WLAN), which allows the STA intending to access an external network, such as the Internet, to achieve more information about a BSS to participate in, and a wireless apparatus for the communication method.

In another general aspect, there is provided a communication method of an STA and an AP in WLAN, which allows the STA to more efficiently select, from a plurality of BSSs that the STA can participate in, a specific BSS desired or a BSS that supports a service discovery protocol compatible with the STA, and a wireless apparatus for the communication method.

In yet another general aspect, there is provided a communication method of an STA and an AP in WLAN, which allows the AP to efficiently provide information about upper service discovery protocols currently used and supported by the AP in its network, and a wireless apparatus for the communication method.

In one general aspect, there is provided a communication method of a station (STA) in a wireless local access network (WLAN), the communication method including: receiving first frames each of which includes upper layer service discovery protocol information from one or more access points (APs); and transmitting an association request frame to an AP that is selected based on upper layer service discovery protocol information received from the one or more APs.

The upper layer service discovery protocol information may be represented in one of the following schemes: a bitmap scheme whereby each of service discovery protocols contained in the upper layer service discovery protocol information is indicated as to whether it is supported by the AP device; an enumeration scheme whereby identification information of each of supported service discovery protocols is included in the upper layer service discovery protocol information; and a hybrid scheme that combines the bitmap scheme and the enumeration scheme.

Each of the first frames may be either a beacon frame or a probe response frame. Each of the first frames may be a response frame that is transmitted in response to a request frame from the station for requesting the upper layer service discovery protocol information. In this case, the communication method may further include, prior to receiving the first frames, receiving beacon frames or probe response frames from the one or more APs, wherein each of the beacon frames or each of the probe response frames includes information that indicates whether the corresponding AP is capable of providing the upper layer service discovery protocol information.

In another general aspect, there is provided a communication method of an access point (AP) in a wireless local access network (WLAN), the communication method including: receiving a first frame that includes upper layer service discovery protocol information to one or more stations (STAs); and receiving an association request frame from a station that has received the first frame.

The upper layer service discovery protocol information may be represented in one of the following schemes: a bitmap scheme whereby each of service discovery protocols contained in the upper layer service discovery protocol information is indicated as to whether it is supported by the AP device; an enumeration scheme whereby identification information of each of supported service discovery protocols is included in the upper layer service discovery protocol information; and a hybrid scheme that combines the bitmap scheme and the enumeration scheme.

The first frame may be either a beacon frame or a probe response frame. The first frame may be a response frame that is transmitted in response to a request frame from the station for requesting the upper layer service discovery protocol information. In this case, the communication method may further include, prior to transmitting the first frame, transmitting a beacon frame or a probe response frame, wherein the beacon frame or the probe response frame includes information that indicates whether the AP is capable of providing the upper layer service discovery protocol information.

In yet another general aspect, there is provided an access point (AP) device which is associated with a station (STA) in a wireless local access network (WLAN), the AP device including: a transceiver; and a processor, wherein the processor transmits to one or more STAs a first frame that includes upper layer service discovery protocol information and the transceiver receives an association request frame from a STA that has received the first frame.

The upper layer service discovery protocol information may be represented in one of the following schemes: a bitmap scheme whereby each of service discovery protocols contained in the upper layer service discovery protocol information is indicated as to whether it is supported by the AP device; an enumeration scheme whereby identification information of each of supported service discovery protocols is included in the upper layer service discovery protocol information; and a hybrid scheme that combines the bitmap scheme and the enumeration scheme.

Other features and aspects will be apparent from the following detailed description, the drawings, and the claims.

### BRIEF DESCRIPTION OF THE DRAWINGS

FIG. 1 is a diagram illustrating an example of all IEEE 802.11 wireless local access network (WLAN) system.

FIG. 2 is a diagram illustrating procedures of connecting a station (STA) to an access point (AP) in an infrastructure basic service set (BSS).

FIG. 3 is a flowchart illustrating a method for communication in a wireless LAN according to an exemplary embodiment.

FIG. 4A is a diagram illustrating an example of a format of a capability information element.

FIG. 4B is a diagram illustrating an example of a format of a pre-association service discovery information element.

FIG. 5A is a table illustrating an example of information contained in a supported upper layer protocol (ULP) bitmap field.

FIG. 5B shows exemplary types of ULP IDs which may be included in the ULP ID sub-field of FIG. 4A or 4B.

FIG. 6A is a diagram illustrating another example of a format of a capability information element.

FIG. 6B illustrates exemplary information that may be contained in the supported ULP count field.

FIG. 7A is a flowchart illustrating procedures of transmitting upper layer protocol information from an AP to an STA according to an exemplary embodiment.

FIG. 7B is a flowchart illustrating procedures of transmitting upper layer protocol information from an AP to an STA according to another exemplary embodiment.

FIG. 7C is a flowchart illustrating procedures of transmitting ULP information from an AP to an STA according to yet another exemplary embodiment.

FIG. 7D is a flowchart illustrating procedures of transmitting ULP information from an AP to an STA according to yet another exemplary embodiment.

FIG. 8 is a block diagram illustrating a configuration of a wireless apparatus according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The exemplary embodiments now will be described more fully hereinafter with reference to the accompanying figures. In the following description, a detailed description of known functions and configurations incorporated herein will be omitted when it may obscure the subject matter with unnecessary detail. Terms used throughout this specification are defined in consideration of functions according to exemplary embodiments, and can be varied according to a purpose of a user or manager, or precedent and so on. Therefore, definitions of the terms should be made on the basis of the overall context.

According to the Institute of Electrical and Electronics Engineers (IEEE) 802.11 standards, a station refers to an arbitrary function medium including a physical layer interface for a wireless medium and a medium access control (MAC), which conforms to rules of IEEE 802.11 standards, and may broadly include both access point (AP) station and non-AP station. However, the AP station may be referred to simply as an AP, and only the non-AP station may be referred to as a “station (STA).” In the following description, a station (STA) refers only to a non-AP station, which is a user device.

The STA may also be referred to as a wireless transmission/reception unit (WTRU), user equipment (UE), a user terminal (UT), an access terminal (AT), a mobile station (MS), a mobile terminal, a subscriber unit, a subscriber station (SS), a wireless apparatus, or a mobile subscriber unit, and may include all or part of functions of these devices. The STA may be implemented as a function of the devices, such as a desktop computer with communication capability, a laptop computer, a tablet computer, a wireless phone, a mobile phone, a smart phone, an e-book reader, a portable multimedia player (PMP), a mobile game console, a navigation device, a digital camera, a digital multimedia broadcasting (DMB) player, a digital audio recorder, a digital audio player, a digital picture recorder, a digital picture player, a digital video recorder, a digital video player, or the like.

The AP may be referred to as a centralized controller, a base station (BS), a node-B (node-B), e node-B, a base transceiver system (BTS), or a cite controller, and may include all or part of functions of these devices.

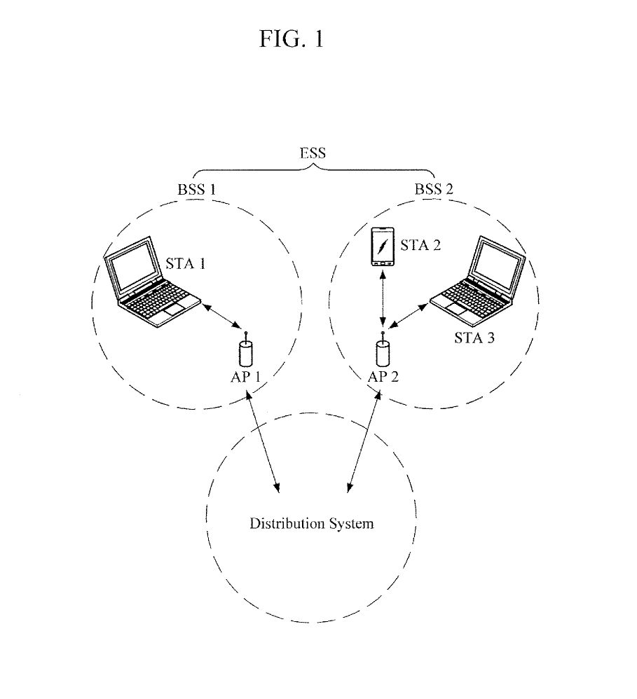

FIG. 1 is a diagram illustrating an example of an IEEE 802.11 wireless LAN system. Referring to FIG. 1, the IEEE 802.11 wireless LAN system includes at least one basic service set (BSS). The BSS refers to an aggregation of STAs, or an aggregation of an AP and STAs which are successfully synchronized and communicate each other, and does not refer to a specific region. The BSS may be classified into an infrastructure BSS or an independent BSS (IBSS). BSS1 and BSS2 as shown in FIG. 1 are, each, an infrastructure BSS.

In the infrastructure BSS, APs (AP1 and AP2) allow their connected STAs (STA1, STA2, and STA3) to access a distribution system (DS) via wireless media. Communication between STAs (e.g., STA2, and STA3) in each BSS (e.g., BSS2) is carried out generally via the AP (e.g., AP2), but if a direct link is established between STAs, the STAs can communicate directly with each other. A plurality of infrastructure BSSs may be connected to each other through the DS. The group of infrastructure BSSs connected through the DS are referred to as an extended service set (ESS).

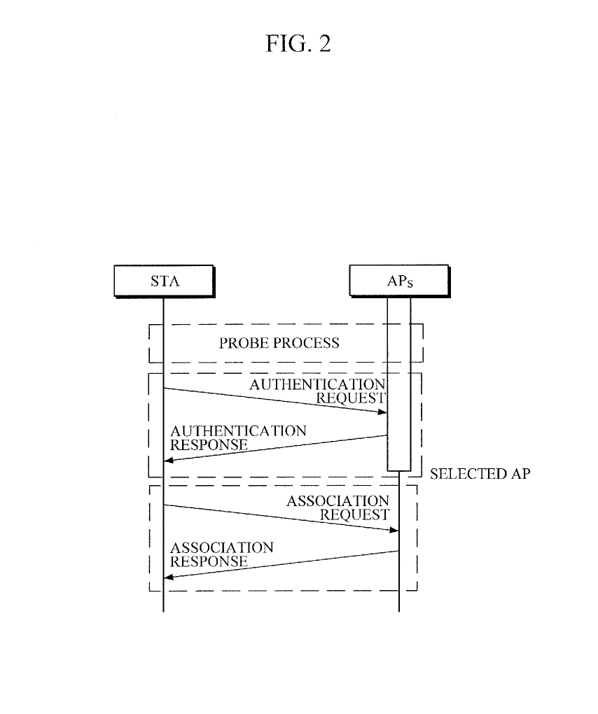

FIG. 2 is a diagram illustrating procedures of connecting an STA to an AP in an infrastructure BSS. As described above, in the infrastructure BSS, a connection between the STA and the AP has to be completed in order to transmit and receive data. Referring to FIG. 2, the procedures of connecting the STA to the AP include largely a probe process, an authentication process, and an association process.

The STA may detect nearby APs through the probe process. The probe process may be divided into passive scanning and active scanning. The passive scanning may be performed by overhearing beacon frames transmitted by one or more APs. According to the active scanning, the STA broadcasts a probe request frame to the one or more APs, and in response, the APs that receive the probe request frame transmit a probe response frame to the STA. The STA may identify the existence of each of the neighboring APs based on the received probe response frame.

After the probe process, the STA and one or more of the detected APs perform the authentication process. According to the IEEE 802.11 standards, an open system algorithm that exchanges two authentication frames and a shared key algorithm that exchanges four authentication frames are used. The STA and the AP may perform the authentication process by exchanging an authentication request frame and an authentication response frame based on such an authentication algorithm.

Finally, the STA selects one of the authenticated APs and the STA and the selected AP perform the association process. To do so, the STA transmits an association request frame to the selected AP. In response to the association request frame, the AP transmits an association response frame to the STA. As such, the association between the STA and the AP is completed by the process of exchanging the association request frame and the association response frame between the STA and the AP.

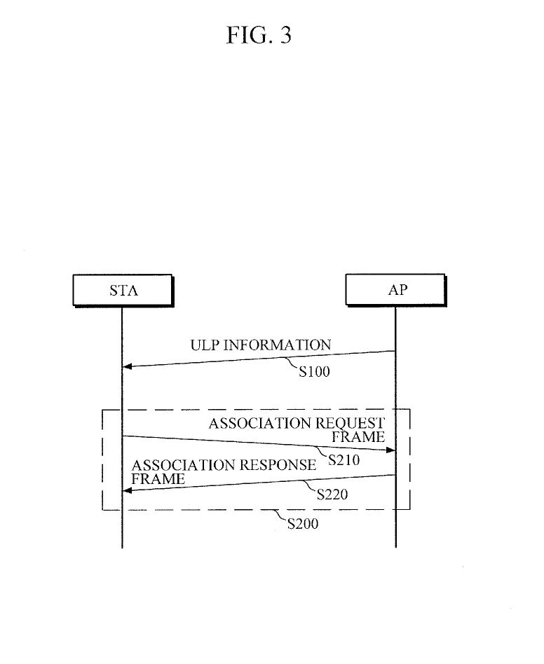

FIG. 3 is a flowchart illustrating a method for communication in a wireless LAN according to an exemplary embodiment.

Referring to FIG. 3, an STA receives upper layer service discovery protocol information (hereinafter, referred to simply as “upper layer protocol information”) from one or more nearby APs, as depicted in S100. The AP transmits a specific frame that includes the upper layer protocol information to the STA. The upper layer protocol information may be broadcast or unicast. In the former case, the AP may broadcast the upper layer protocol information by transmitting a specific frame (e.g., a beacon frame) at specific intervals or by transmitting a broadcast frame at irregular intervals. In the latter case, the AP may transmit the upper layer protocol information to the STA by sending a response frame that includes the upper layer protocol information in response to a request from the STA.

In the exemplary embodiment, S100 in which the AP transmits the upper layer protocol information and the STA receives the upper layer protocol information is performed prior to the association process S200 for the STA and an AP, and more precisely, prior to S210 in which the STA transmits an association request frame to a selected AP. As described above, the association process S200 includes a process of transmitting the association request frame from the STA to the selected AP, as depicted in S210, and a process of transmitting an association response frame from the AP to the STA, as depicted in S220. The timing and procedures of transmitting the upper layer protocol information from the AP to the STA in a broadcast or unicast manner will be described below.

According to the exemplary embodiment, by referencing the received upper layer protocol information, the STA, more specifically, a user may select an AP with which to perform the association process S200 or may determine whether to proceed with the association process S200 with a specific AP. For example, if one or more APs transmit the upper layer protocol information in a broadcast manner and the STA receives the upper layer protocol information, the STA identifies which service discovery protocol is supported by each AP, and thereafter, the STA may choose the AP that supports a specific service discovery protocol of interest and proceed with the association process S200.

In another example, if the AP transmits the upper layer protocol information to the STA in response to a request from the STA, the STA may determine whether or not the AP supports or provides a specific service discovery protocol of interest and then determine whether to proceed with the association process S200 with the AP. By doing so, the STA can avoid association with an AP which does not support or provide the specific service discovery protocol of interest, and thereby can promptly perform the association process S200 with an AP that supports or provides the specific service discovery protocol.

Here, “upper layer service discovery protocol information” or “upper layer protocol information” may refer to information on service discovery protocol used to discover various services specified on an upper layer of the MAC layer. That is, the upper layer protocol information refers to information used by an AP to indicate an upper layer service discovery protocol that the AP is using and supporting in its network.

The upper layer protocol information may be represented in a given scheme (e.g., bitmap scheme) in which, for example, it is indicated whether the AP supports each of predesignated service discovery protocols. Alternatively, the upper layer protocol information may be represented by enumerating service discovery protocols that are supported by the AP (i.e., enumeration scheme), but aspects of the present disclosure are not limited thereto. For example, the upper layer protocol information may be represented by combining the above schemes (hybrid scheme).

It will be apparent to those ordinary skilled in the art that the aforementioned upper layer service discovery protocols may include the presently used service discovery protocols as well as new service discovery protocols to be utilized or newly specified in the future. The presently used service discovery protocols may include, for example, Domain Name System Service Discovery, which is part of Apple's Bonjour technology, Service Location Protocol (SLP), Simple Service Discovery Protocol (SSDP) as used in Universal Plug and Play (UPnP), Universal Description Discovery and Integration(UDDI) for web services, JINI for Java objects, Bluetooth Service Discovery Protocol), Salutation, Extensible Messaging and Presence Protocol Service Protocol, Web Services Dynamic Discovery, multicast Dynamic Host Configuration Protocol, Internet Storage Name Service, Web Proxy Autodiscovery Protocol, Dynamic Host Configuration Protocol, eXtensible resource Descriptor Sequence, emergency services, such as e911 or Next Generation 911, location service, MQTT(Message Queue Telemetry Transport), and the like.

The upper layer protocol information transmitted, as depicted in S100, may be included in a frame that is broadcast or unicast as information element (IE) in a given format by the AP to a specific STA. For example, the upper layer protocol information may be included in a frame as one of capability IEs to contain information on capabilities of the AP or as a pre-association service discovery information element.

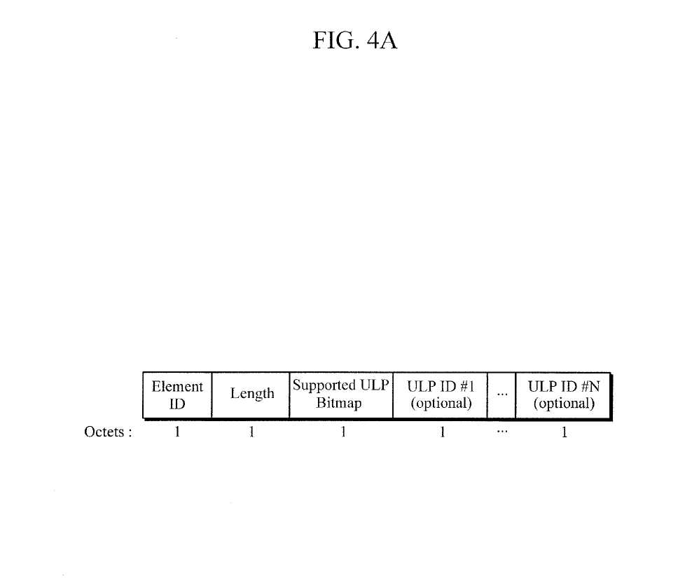

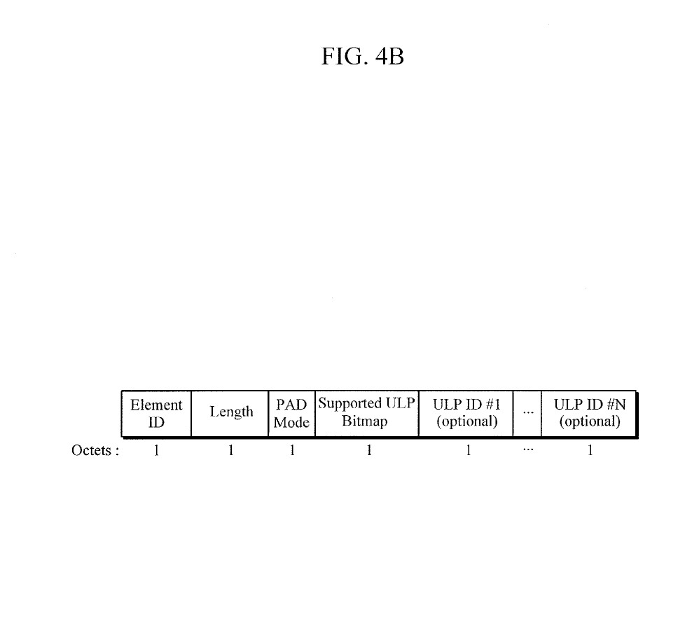

FIG. 4A is a diagram illustrating an example of a format of a capability information element, which may be included in a beacon frame. An IE as shown in FIG. 4A may be referred to as a support upper layer protocol (ULP) IE, which is one of capability information elements, and it is only exemplary.

Referring to FIG. 4A, the support ULP IE includes an element ID, a length field, a supported ULP bitmap field, and one or more ULP ID fields. The element ID field contains an identifier of the corresponding IE, and the length field contains a value that indicates the length of the following fields. The IE contains specified information on a service discovery protocol supported by the AP, only using the supported ULP bitmap field or both the bitmap field and m (m is an integer greater than 1) ULP ID fields.

FIG. 4B is a diagram illustrating an example of a format of a pre-association service discovery information element. Referring to FIG. 4B, the pre-association service discovery IE includes an element ID field, a length field, a padding mode (PAD mode) field, a supported ULP bitmap field, and one or more ULP ID fields. The element ID contains an identifier of the corresponding IE, the length field contains a value that indicates the length of the following fields, and the PAD mode field contains information that indicates padding mode. In addition, in the same manner as the format shown in FIG. 4A, the IE shown in FIG. 4B also contains specified information on a service discovery protocol supported by the AP, only using the supported ULP bitmap field or both the bitmap field and m (m is an integer greater than 1) ULP ID fields. The detailed descriptions will be provided below.

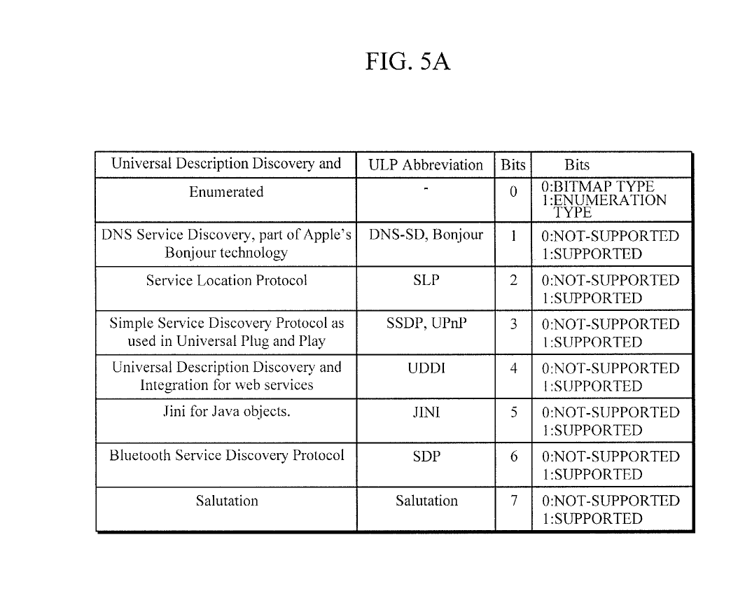

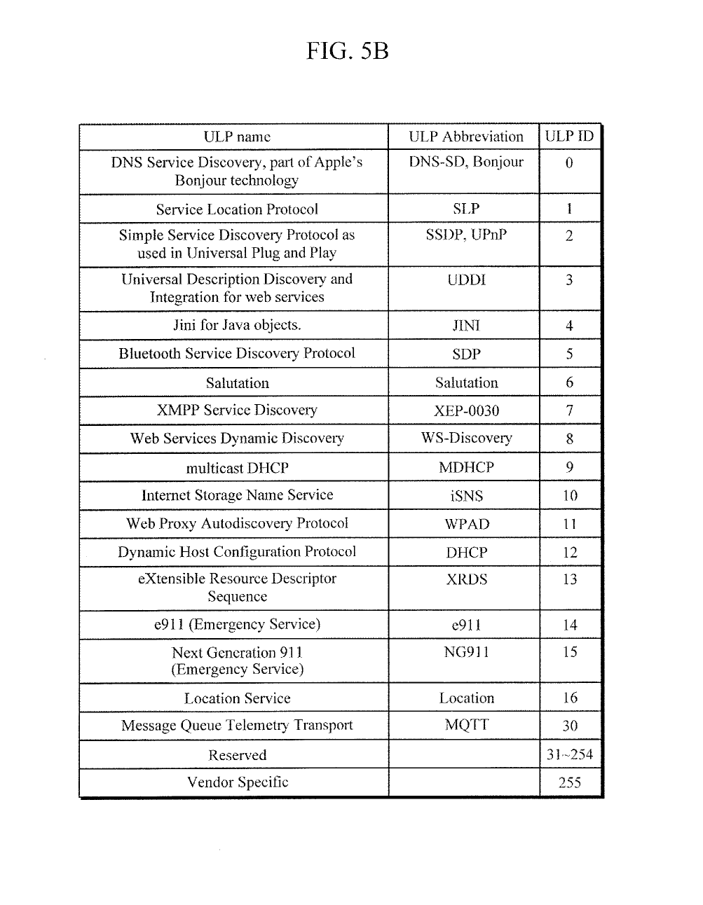

FIG. 5A is a table illustrating an example of information contained in the supported ULP bitmap field.

Referring to FIG. 5A, the supported ULP bitmap field includes a sub field, i.e., enumerated field, to indicate whether the supported ULP bitmap field includes an enumerated sub-field. If the enumerated field has a value of “0,” it indicates that the supported ULP bitmap field is of a pure bitmap type that does not include an enumerated sub-field (in this case, the length field shown in FIG. 4A or 4B may have a value of “1”). If the enumerated field has a value of “1,” it indicates that the supported ULP bitmap field is of a hybrid type which is the combination of a bitmap scheme and an enumerated scheme (in this case, one or more ULP ID fields are contained, and hence the length field shown in FIG. 4A or 4B may have a value of “2” or greater, i.e., 1+N). The above descriptions of the enumerated field are only exemplary. FIG. 5A shows ULP abbreviations, each of which corresponds to each ULP, and they are only provided to facilitate the understanding of the ULP.

In addition, regarding the remaining sub-fields of the supported ULP bitmap field, each contains 1 bit to indicate whether a specific upper layer service discovery protocol is supported. In FIG. 5A, it is illustrated that a value of “0” in each sub-field indicates that a corresponding upper layer service discovery protocol is not supported and a value of “1” indicates that the corresponding upper layer service discovery protocol is supported. However, it will be apparent to those ordinary skilled in the art that the opposite is also possible. Although, in FIG. 5A, a total of 7 upper layer service discovery protocols (Domain Name System Service Discovery which is a part of Apple's Bonjour technology, Service Location Protocol (SLP), Simple Service Discovery Protocol (SSDP) as used in Universal Plug and Play (UPnP), Universal Description Discovery and Integration(UDDI) for web services, JINI for Java objects, Bluetooth Service Discovery Protocol, and Salutation) are exemplary shown, it will be apparent to those skilled in the art that the number or types of the protocols may vary.

FIG. 5B shows exemplary types of ULP IDs which may be included in the ULP ID sub-field of FIG. 4A or 4B. In FIG. 5B, ULP abbreviations, each of which corresponds to each upper layer service discovery protocol, and they are only provided to facilitate the understanding of the upper layer service discovery protocols. Also, it will be apparent to those skilled in the art that the types of and values assigned to the respective upper layer service discovery protocols shown in FIG. 5B are only exemplary.

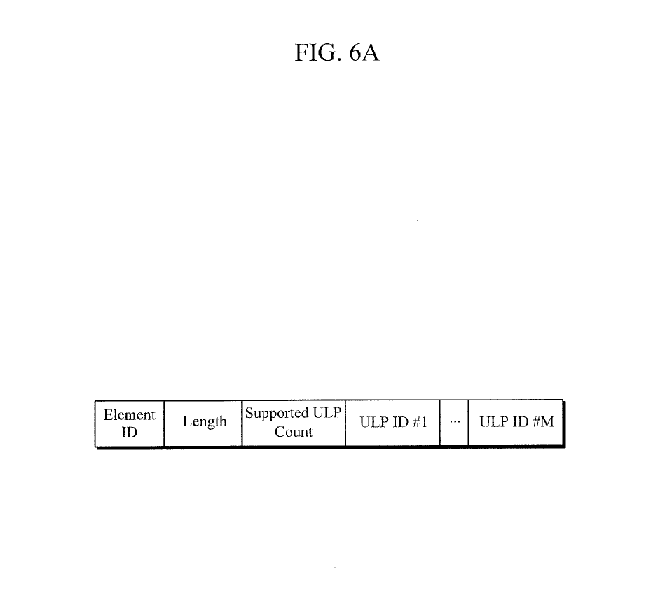

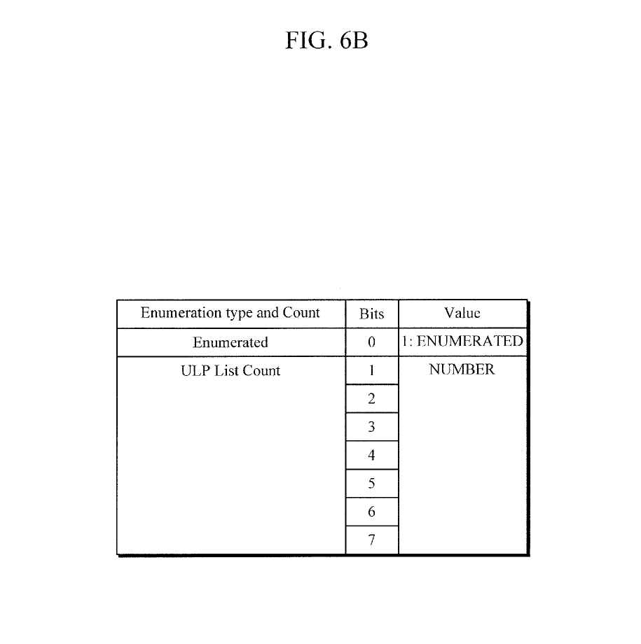

FIG. 6A is a diagram illustrating another example of a format of a capability information element, which may also be included in a beacon frame. The information element shown in FIG. 6A may also be referred to as a supported upper layer protocol (ULP) IE, which is one element of the capability IE. Referring to FIG. 6A, the supported ULP IE includes an element ID field, a length field, a supported ULP count field, and one or more ULP ID fields. The element ID field contains an identifier of the corresponding IE, the length field contains a value that indicates the length of the following fields, and m ULP ID fields, each, contain a value of the ULP ID, as described above and illustrated in FIG. 5B.

In addition, the supported ULP count field may include information that indicates the number (i.e., m, which is an integer greater than 1) of ULP ID fields. FIG. 6B illustrates exemplary information that may be contained in the supported ULP count field, wherein the first bit of the information indicates whether the supported ULP IE is of an enumeration type and the remaining 7 bits may indicate the number of the subsequent ULP ID fields.

As described above, by using the IEs as shown in FIGS. 4A and 4B, the information regarding the upper layer service discovery protocols supported by the AP may be represented in a bitmap scheme or in a hybrid scheme that combines the bitmap and the enumeration schemes. In addition, by using the IE as shown in FIG. 6A, the information regarding the upper layer service discovery protocols supported by the AP may be represented in an enumeration scheme.

Herein, the timing and procedures of transmitting the aforesaid upper layer protocol information from the AP to the STA in a broadcast or unicast manner will be described in detail.

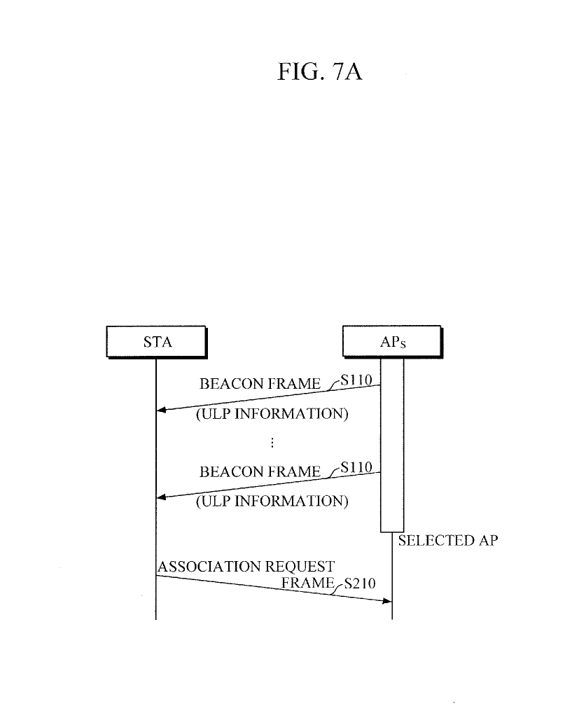

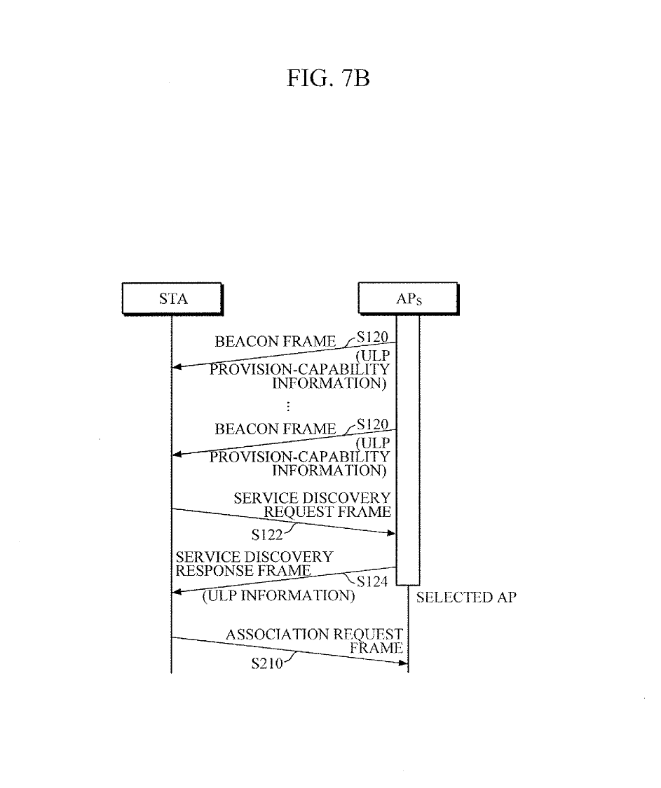

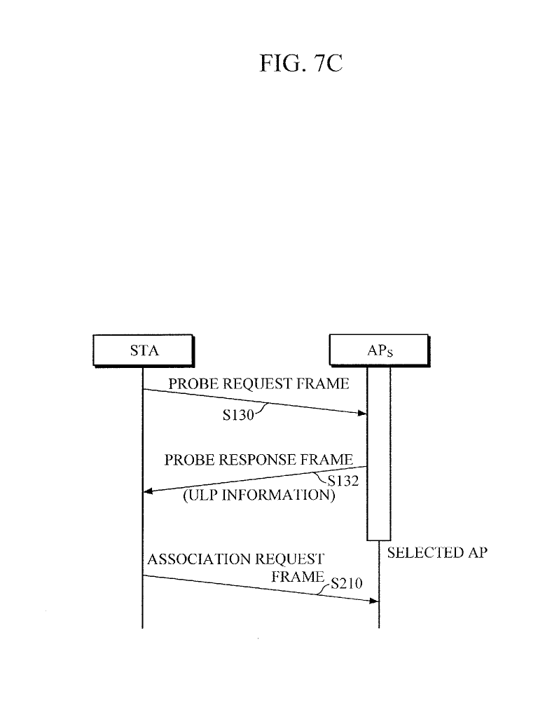

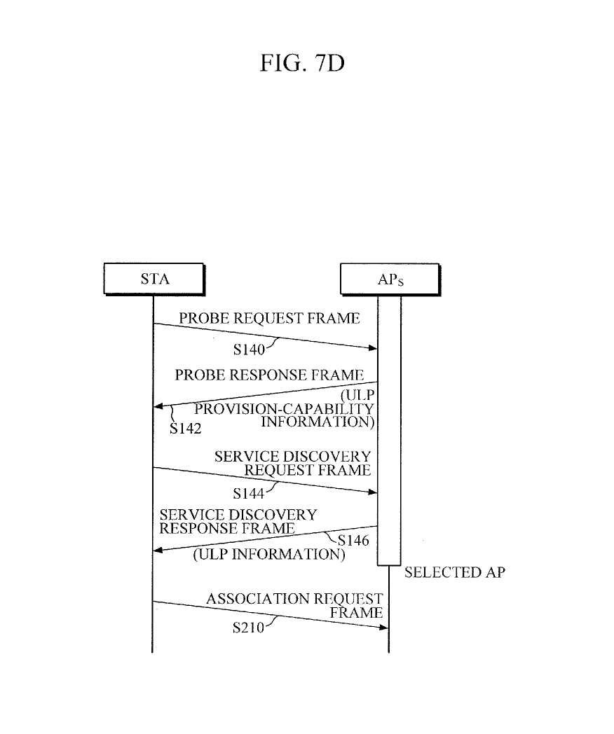

FIG. 7A is a flowchart illustrating procedures of transmitting upper layer protocol information from an AP to an STA according to an exemplary embodiment. Referring to FIG. 7A, one or more APs transmits upper layer protocol information by sending a beacon frame that includes the upper layer protocol information at intervals, as depicted in S110. In this case, it is apparent that the upper layer protocol information is transmitted in a broadcast manner. The STA that has received the beacon frame selects an AP with which to perform the association process, and then the STA transmits an association request frame to the selected AP, as depicted in S210.

FIG. 7B is a flowchart illustrating procedures of transmitting upper layer protocol information from an AP to an STA according to another exemplary embodiment. Referring to FIG. 7B, one or more APs transmit beacon frames at intervals, as depicted in S120. In this case, each beacon frame transmitted does not include ULP information supported by the corresponding AP, but rather includes information that indicates whether the corresponding AP is capable of providing the ULP information. For example, each beacon frame may include ULP information provision-capability information. In addition, the STA that has received the beacon frame transmits a service discovery request frame to one or more APs that are capable of providing the ULP information, as depicted in S122. Here, the service discovery request frame is an example of a frame that requests a specific AP for specified information regarding an upper layer service discovery protocol supported by the AP, and the name thereof is merely exemplary. Thereafter, the AP that has received the service discovery request frame transmits a service discovery response frame including the ULP information to the STA, as depicted in S124. Then, the STA that has received the service discovery response frame selects an AP with which to perform an association process based on the ULP information contained in the received frame and transmits an association request frame to the selected AP, as depicted in S210.

FIG. 7C is a flowchart illustrating procedures of transmitting ULP information from an AP to an STA according to yet another exemplary embodiment. Referring to FIG. 7C, the STA transmits a probe request frame in a broadcast manner, as depicted in S130. One or more APs that have received the probe request frame transmit ULP information to the STA by sending a probe response frame that includes the ULP information, as depicted in S132. In this case, it is apparent that the ULP information is transmitted in a unicast manner. The STA that has received the probe response frame selects an AP with which to perform an association process based on the ULP information contained in the received frame and transmits an association request frame to the selected AP, as depicted in S210.

FIG. 7D is a flowchart illustrating procedures of transmitting ULP information from an AP to an STA according to yet another exemplary embodiment. Referring to FIG. 7D, the STA transmits a probe request frame in a broadcast manner, as depicted in S140. Then, one or more APs that have received the probe request frame transmits a probe response frame to the STA, as depicted in S142. In S142, the probe response frame transmitted does not include ULP information supported by the corresponding AP, but rather includes information that indicates whether the corresponding AP is capable of providing the ULP information. For example, each probe response frame may include ULP information provision-capability information. The STA that has received the probe response frame transmits a service discovery request frame to one or more APs that are capable of providing the ULP information, as depicted in S134. Here, the service discovery request frame is an example of a frame that requests a specific AP for specified information regarding an upper layer service discovery protocol supported by the AP, and the name thereof is merely exemplary. Thereafter, the AP that has received the service discovery request frame transmits a service discovery response frame including the ULP information to the STA, as depicted in S136. Then, the STA that has received the service discovery response frame selects an AP with which to perform an association process based on the ULP information contained in the received frame and transmits an association request frame to the selected AP, as depicted in S210.

According to the exemplary embodiments of FIGS. 7B and 7D, after receiving from the AP the information about the AP's capability of providing an upper layer service, the STA transmits the service discovery request frame as depicted in S122 and S144. However, the STA may transmit a service discovery request frame to the AP without having received from the AP the information about the AP's capability of providing an upper layer service. In this case, transmission of the service discovery request frame from the STA to the AP and transmission of the service discovery response frame from the AP to the STA may be performed according to separate procedures that are not specified by IEEE 802.11, or they may be performed as a part of designated procedures of transmitting and receiving frames before the STA and the AP complete the association process in accordance with the rules of IEEE 802.11.

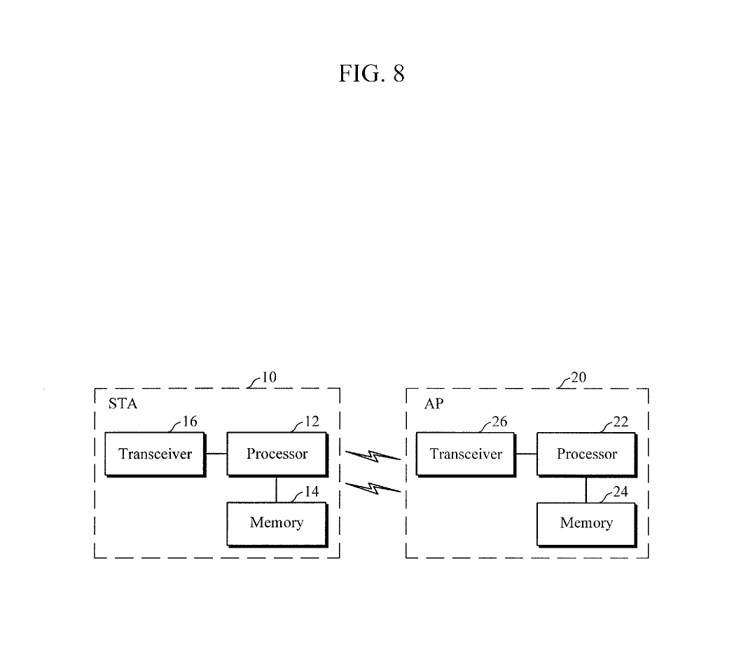

FIG. 8 is a block diagram illustrating a configuration of a wireless apparatus according to an exemplary embodiment.

Referring to FIG. 8, an STA 10 includes a processor 12, a memory 14, and a transceiver 16, and the AP 20 may also include a processor 22, a memory 24, and a transceiver 26. The transceivers 16 and 26 may transmit and receive wireless signals, and may implement a physical layer that conforms to, for example, an IEEE 802 system. The processors 12 and 22 are connected to the transceivers 16 and 26, respectively, and implement a physical layer and/or a MAC layer which conforms to an IEEE 802 system. The processors 12 and 22 may be configured to perform the operations according to the above exemplary embodiments. In addition, modules which implement the operations of the AP and the STA according to the aforesaid various exemplary embodiments may be stored in the memories 14 and 24 and executed by the processors 12 and 24. The memories 14 and 24 may be included in the processors 12 and 22 or may be installed external to the processors 12 and 22 and establish connection to the processors 12 and 22 through publicly known means.

The configurations of the STA and AP devices may be implemented such that the aforesaid various exemplary embodiments can be independently applied thereto or two or more embodiments are simultaneously applied thereto. The redundant details of the configurations are omitted for the sake of clarity.

According to the exemplary embodiments described above, an STA to be connected to an external network, such as the Internet, is able to identify which upper layer service discovery protocol is supported by each AP before the STA and a specific AP perform an association process. Hence, even if there are a plurality of APs that can be connected, there is no need for performing an association process with each AP in an effort to identify an upper level service discovery protocol supported by each AP. In addition, the AP may efficiently provide upper layer service discovery protocol information to the STA using a bitmap scheme, an enumeration scheme, or a hybrid scheme that combines both bitmap and enumeration schemes.

Exemplary embodiments of the present invention may be implemented by various means. For example, the exemplary embodiments of the present invention may be implemented firmware, software, or a combination thereof, or the like.

In the implementation by the hardware, a method according to exemplary embodiments of the present invention may be implemented by application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the implementation using the firmware or the software, a method according to exemplary embodiments of the present invention may be implemented by modules, procedures, functions, or the like, that perform functions or operations described above. Software codes are stored in a memory unit and may be driven by a processor. The memory unit is disposed in or out the processor and may transmit and receive data to and from the well-known various units.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A communication method of a station (STA) in a wireless local access network (WLAN), the communication method comprising:
receiving first frames each of which includes upper layer service discovery protocol information from one or more access points (APs); and
transmitting an association request frame to an AP that is selected based on upper layer service discovery protocol information received from the one or more APs.

2. The communication method of claim 1, wherein the upper layer service discovery protocol information is represented in a bitmap scheme whereby each of service discovery protocols contained in the upper layer service discovery protocol information is indicated as to whether it is supported by the corresponding AP.

3. The communication method of claim 1, wherein the upper layer service discovery protocol information is represented in an enumeration scheme whereby identification information of each of supported service discovery protocols is included in the upper layer service discovery protocol information.

4. The communication method of claim 1, wherein the upper layer service discovery protocol information is represented in a hybrid scheme that combines a bitmap scheme and an enumeration scheme.

5. The communication method of claim 1, wherein each of the first frames is either a beacon frame or a probe response frame.

6. The communication method of claim 1, wherein each of the first frames is a response frame that is transmitted in response to a request frame from the station for requesting the upper layer service discovery protocol information.

7. The communication method of claim 6, further comprising, prior to receiving the first frames, receiving beacon frames or probe response frames from the one or more APs,
wherein each of the beacon frames or each of the probe response frames includes information that indicates whether the corresponding AP is capable of providing the upper to layer service discovery protocol information.

8. A communication method of an access point (AP) in a wireless local access network (WLAN), the communication method comprising:
receiving a first frame that includes upper layer service discovery protocol information to one or more stations (STAs); and
receiving an association request frame from a station that has received the first frame.

9. The communication method of claim 8, wherein the upper layer service discovery protocol information is represented in a bitmap scheme whereby each of service discovery protocols contained in the upper layer service discovery protocol information is indicated as to whether it is supported by the AP.

10. The communication method of claim 8, wherein the upper layer service discovery protocol information is represented in an enumeration scheme whereby identification information of each of supported service discovery protocols is included in the upper layer service discovery protocol information.

11. The communication method of claim 8, wherein the upper layer service discovery protocol information is represented in a hybrid scheme that combines a bitmap scheme and an enumeration scheme.

12. The communication method of claim 8, wherein the first frame is either a beacon frame or a probe response frame.

13. The communication method of claim 8, wherein the first frame is a response frame that is transmitted in response to a request frame from the station for requesting the upper layer service discovery protocol information.

14. The communication method of claim 13, further comprising, prior to transmitting the first frame, transmitting a beacon frame or a probe response frame,
wherein the beacon frame or the probe response frame includes information that indicates whether the AP is capable of providing the upper layer service discovery protocol information.

15. An access point (AP) device which is associated with a station (STA) in a wireless local access network (WLAN), the AP device comprising:
a transceiver; and
a processor,
wherein the processor transmits to one or more STAs a first frame that includes upper layer service discovery protocol information and the transceiver receives an association request frame from a STA that has received the first frame.

16. The AP device of claim 15, wherein the upper layer service discovery protocol information is represented in one of the following schemes: a bitmap scheme whereby each of service discovery protocols contained in the upper layer service discovery protocol information is indicated as to whether it is supported by the AP device; an enumeration scheme whereby identification information of each of supported service discovery protocols is included in the upper layer service discovery protocol information; and a hybrid scheme that combines the bitmap scheme and the enumeration scheme.
